(19) United States
(12) Patent Application Publication
(10) Pub. No.: US 2024/0396140 A1
(43) Pub. Date: Nov. 28, 2024

(54) SYSTEMS AND METHODS FOR SEALING INTERFACES OF TRACTION BATTERY PACKS

(71) Applicant: FORD GLOBAL TECHNOLOGIES, LLC, Dearborn, MI (US)

(72) Inventors: Xiaogang Zhang, Novi, MI (US); Nathaniel Conti, Canton, MI (US); Todd John Mueller, Canton, MI (US); Jeffrey Wrenbeck, Royal Oak, MI (US); Samuel Jeffrey Tomlinson, Farmington Hills, MI (US); Kori Baij, Dearborn, MI (US)

(21) Appl. No.: 18/322,071

(22) Filed: May 23, 2023

(51) Int. Cl. H01M 50/24; H01M 50/249; H01M 50/262

(52) U.S. Cl. CPC H01M 50/24; H01M 50/249; H01M 50/262; H01M 2220/20

(57) ABSTRACT

Systems and methods are provided for sealing interfaces of a traction battery pack. A gasket seal may be arranged to seal an interface between a first enclosure section and a second enclosure section of an enclosure assembly of the traction battery pack. The gasket seal may be disposed within a pocket that is located between vertical shield portions of the first and second enclosure sections. One or more fasteners (e.g., bolts, spot welds, clips, etc.) may be employed to secure the vertical portions together. The gasket seal may be insulated by an air gap that is positioned inboard and thus upstream from the gasket seal.

### TECHNICAL FIELD

This disclosure relates generally to electrified vehicle traction battery packs, and more particularly to sealing interfaces of a traction battery pack.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, an enclosure assembly including a first enclosure section and a second enclosure section, a gasket seal arranged within a pocket between a first peripheral flange of the first enclosure section and a second peripheral flange of the second enclosure section, and an air gap arranged between the first peripheral flange and the second peripheral flange at a location inboard from the gasket seal.

In a further non-limiting embodiment of the foregoing traction battery pack, the first peripheral flange at least partially envelops the second peripheral flange.

In a further non-limiting embodiment of either of the foregoing traction battery packs, the first peripheral flange includes a horizontal shield portion and a vertical shield portion that extends from the horizontal shield portion, and the second peripheral flange includes a horizontal shield portion and a vertical shield portion that extends from the horizontal shield portion.

In a further non-limiting embodiment of any of the foregoing traction battery packs, the horizontal shield portion of the first peripheral flange extends over the horizontal shield portion of the second peripheral flange.

In a further non-limiting embodiment of any of the foregoing traction battery packs, the gasket seal is arranged between the vertical shield portion of the first peripheral flange and the vertical shield portion of the second peripheral flange.

In a further non-limiting embodiment of any of the foregoing traction battery packs, a fastener secures the vertical shield portion of the first peripheral flange to the vertical shield portion of the second peripheral flange.

In a further non-limiting embodiment of any of the foregoing traction battery packs, the fastener includes a bolt.

In a further non-limiting embodiment of any of the foregoing traction battery packs, the fastener includes a spot weld or a clip.

In a further non-limiting embodiment of any of the foregoing traction battery packs, the vertical shield portion of the first peripheral flange includes a hook feature that engages a dent feature of the vertical horizontal shield portion of the second peripheral flange.

In a further non-limiting embodiment of any of the foregoing traction battery packs, the air gap is between the horizontal shield portion of the first peripheral flange and the horizontal shield portion of the second peripheral flange.

In a further non-limiting embodiment of any of the foregoing traction battery packs, the horizontal shield portion of the first peripheral flange contacts the horizontal shield portion of the second peripheral flange at a flange-to-flange interface.

In a further non-limiting embodiment of any of the foregoing traction battery packs, a flat surface of the horizontal shield portion of the first peripheral flange contacts a curved portion of the horizontal shield portion of the second peripheral flange at the flange-to-flange interface.

In a further non-limiting embodiment of any of the foregoing traction battery packs, the air gap extends from the flange-to-flange interface to a leading edge of the gasket seal.

A traction battery pack according to another exemplary aspect of the present disclosure includes, among other things, an enclosure assembly including a first enclosure section and a second enclosure section that cooperate to establish an interior area. A battery array is positioned within the interior area. A gasket seal is arranged between a first peripheral flange of the first enclosure section and a second peripheral flange of the second enclosure section. The first peripheral flange contacts the second peripheral flange at a flange-to-flange interface. An air gap extends between the flange-to-flange interface and a leading edge of the gasket seal.

In a further non-limiting embodiment of the foregoing traction battery pack, the gasket seal is received in a pocket that is between a vertical shield portion of the first peripheral flange and a vertical shield portion of the second peripheral flange.

In a further non-limiting embodiment of either of the foregoing traction battery packs, the vertical shield portion of the first peripheral flange extends downwardly from a horizontal shield portion of the first peripheral flange, and the vertical shield portion of the second peripheral flange extends downwardly from a horizontal shield portion of the second peripheral flange.

In a further non-limiting embodiment of any of the foregoing traction battery packs, the horizontal shield portion of the first peripheral flange abuts the horizontal shield portion of the second peripheral flange to establish the flange-to-flange interface.

In a further non-limiting embodiment of any of the foregoing traction battery packs, a flat surface of the horizontal shield portion of the first peripheral flange contacts a curved portion of the horizontal shield portion of the second peripheral flange at the flange-to-flange interface.

In a further non-limiting embodiment of any of the foregoing traction battery packs, a fastener secures the vertical shield portion of the first peripheral flange to the vertical shield portion of the second peripheral flange.

In a further non-limiting embodiment of any of the foregoing traction battery packs, the fastener includes a bolt, a spot weld, or a clip.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is a perspective view of a traction battery pack for an electrified vehicle.

FIG. 3 is an exploded view of the traction battery pack of FIG. 2.

FIG. 4 is a blown-up view of Area 4 of FIG. 2.

FIG. 5 is a cross-sectional view of section 5-5 of FIG. 4.

FIG. 6 schematically illustrates a mechanical fastener for increasing the structural integrity of an enclosure assembly of a traction battery pack.

FIG. 7 schematically illustrates another mechanical fastener for increasing the structural integrity of an enclosure assembly of a traction battery pack.

FIG. 8 schematically illustrates yet another mechanical fastener for increasing the structural integrity of an enclosure assembly of a traction battery pack.

FIGS. 9A and 9B illustrate an exemplary sealing interface of a traction battery pack enclosure assembly.

FIG. 10 schematically illustrates another exemplary sealing interface of a traction battery pack enclosure assembly.

### DETAILED DESCRIPTION

This disclosure details systems and methods for sealing interfaces of a traction battery pack. A gasket seal may be arranged to seal an interface between a first enclosure section and a second enclosure section of an enclosure assembly of the traction battery pack. The gasket seal may be disposed within a pocket that is located between vertical shield portions of the first and second enclosure sections. One or more fasteners (e.g., bolts, spot welds, clips, etc.) may be employed to secure the vertical portions together. The gasket seal may be insulated by an air gap that is positioned inboard and thus upstream from the gasket seal. These and other features are discussed in greater detail in the following paragraphs of this detailed description.

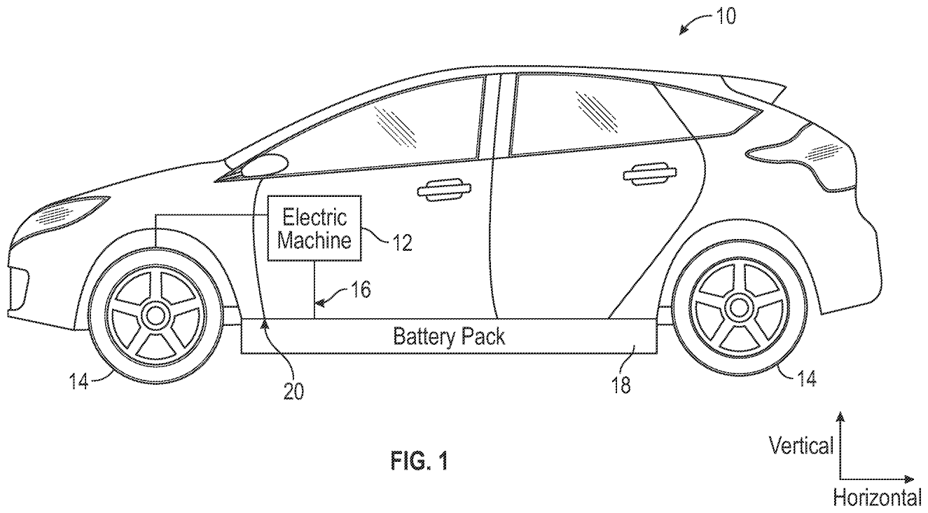

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

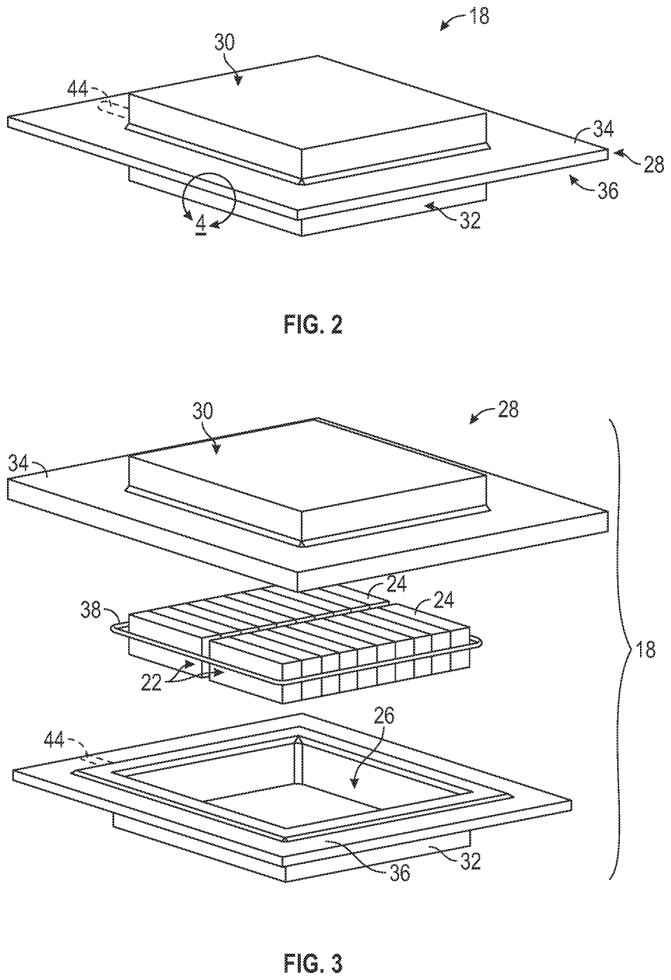

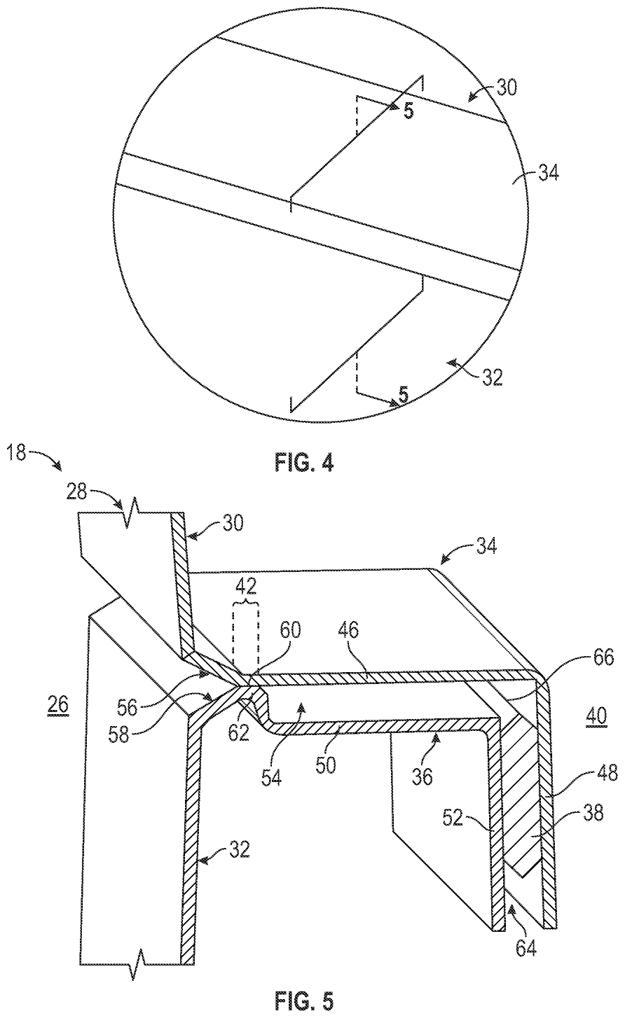

FIGS. 2, 3, and 4 illustrate additional details associated with the traction battery pack 18 of the electrified vehicle 10. The traction battery pack 18 may include one or more battery arrays 22 (e.g., battery assemblies or groupings of rechargeable battery cells 24) capable of outputting electrical power to power the electric machine 12 and/or other electrical loads of the electrified vehicle 10.

The battery cells 24 may be stacked side-by-side along a stack axis to construct a grouping of battery cells 24, sometimes referred to as a “cell stack.” The total number of battery arrays 22 and battery cells 24 provided within the traction battery pack 18 is not intended to limit this disclosure.

In an embodiment, the battery cells 24 of each battery array 22 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The battery arrays 22 and various other battery internal components (e.g., bussed electrical center, battery electric control module, wiring, connectors, etc.) may be housed within an interior area 26 of an enclosure assembly 28. The enclosure assembly 28 may include an enclosure cover 30 and an enclosure tray 32. The enclosure cover 30 may be secured (e.g., bolted, welded, adhered, etc.) to the enclosure tray 32 to provide the interior area 26. The size, shape, and overall configuration of the enclosure assembly 28 is not intended to limit this disclosure.

The enclosure cover 30 may include a first peripheral flange 34 that projects outward from the interior area 26, and the enclosure tray 32 may include a second peripheral flange 36 that projects outward from the interior area 26. The first peripheral flange 34 and the second peripheral flange 36 project horizontally in this example, but could project in other directions. Horizontal and vertical, for purposes of this disclosure, are with reference to ground in a general orientation of the traction battery pack 18 when installed on the electrified vehicle 10 of FIG. 1.

The enclosure cover 30 and the enclosure tray 32 may be metallic or metallic alloy structures. However, other materials or combinations of materials could be utilized within the scope of this disclosure. One or both of the enclosure cover 30 and enclosure tray 32 could be a stamping, an extruded component, or a diecast component, for example.

Referring now to FIG. 5, with continued reference to FIGS. 2-4, a gasket seal 38 or “sealing ring” may be disposed between the first peripheral flange 34 and the second peripheral flange 36. The gasket seal 38 may be arranged to extend circumferentially continuously about a perimeter of the interior area 26. The gasket seal 38 is configured to block moisture and contaminants from entering the interior area 26 from an ambient environment 40 outside of the traction battery pack 18.

The gasket seal 38 may be substantially isolated from the interior area 26 but still able to seal a gas exchange between the interior area 26 and the ambient environment 40. For example, if a battery thermal event in the interior area 26 results in increased thermal energy and vented gas, a flange-to-flange interface 42 between the first peripheral flange 34 and the second peripheral flange 36 of the enclosure assembly 28 may act as a barrier for blocking vented gas and thermal energy from impinging directly on the gasket seal 38. This can help maintain the integrity of the gasket seal 38 and ensure that the vented gas and thermal energy is expelled from the interior area 26 at a desired area, such as through a vent port 44 (see FIGS. 2 and 3), for example.

The first peripheral flange 34 and the second peripheral flange 36 may cooperate to shield the gasket seal 38. In some implementations, the first peripheral flange 34 may at least partially surround, envelop, or wrap around the second peripheral flange 36 to shield the gasket seal 38. In other implementations, the second peripheral flange 36 may at least partially surround, envelop, or wrap around the first peripheral flange 34 to shield the gasket seal 38 (see, e.g., FIG. 10).

The first peripheral flange 34 of the enclosure cover 30 may include a horizontal shield portion 46 and a vertical shield portion 48 that extends vertically away from the horizontal shield portion 46 (here, in a direction toward ground). The second peripheral flange 36 of the enclosure tray 32 may include a horizontal shield portion 50 and a vertical shield portion 52 that extends vertically away from the horizontal shield portion 50 (here, in a direction toward ground).

The vertical shield portions 48, 52 may extend downwardly at about a 90 degree angle relative to the horizontal shield portions 46, 50. In this disclosure, the term “about” means that the expressed quantities or ranges need not be exact but may be approximated and/or larger or smaller, reflecting acceptable tolerances, conversion factors, measurement error, etc. The downward-extending configuration of the vertical shield portions 48, 52 substantially eliminates the ability of moisture to enter into the interior area 26 of the traction battery pack 18 from the ambient environment 40.

The horizontal shield portion 46 of the first peripheral flange 34 may extend over top of the horizontal shield portion 50 of the second peripheral flange 36. An air gap 54 may extend between the horizontal shield portion 46 and the horizontal shield portion 50.

The horizontal shield portion 46 and the horizontal shield portion 50 may be arranged to directly contact one another at the flange-to-flange interface 42. For example, a leading edge 56 of the horizontal shield portion 46 may be received in abutting contact with a leading edge 58 of the horizontal shield portion 50 at the flange-to-flange interface 42. The leading edge 56 may include a flat surface 60, and the leading edge 58 may include a curved portion 62. The flange-to-flange interface 42 may therefore be located where the flat surface 60 contacts the curved portion 62. In an embodiment, the flange-to-flange interface 42 is at least 2 millimeters wide.

The vertical shield portion 48 of the first peripheral flange 34 may be positioned laterally outward of the vertical shield portion 52 of the second peripheral flange 36. A pocket 64 may extend between the vertical shield portion 48 and the vertical shield portion 52.

The gasket seal 38 may be positioned within the open space provided by the pocket 64. The gasket seal 38 may thus be vertically arranged between the vertical shield portions 48, 52.

The air gap 54 may extend between the flange-to-flange interface 42 and a leading edge 66 of the gasket seal 38. At this location, the air gap 54 is positioned to insulate the gasket seal 38 and reduce maximum skin temperatures at the leading edge 66 of the gasket seal 38. In some implementations, the air gap 54 may extend an entire distance from the flange-to-flange interface 42 to the leading edge 66.

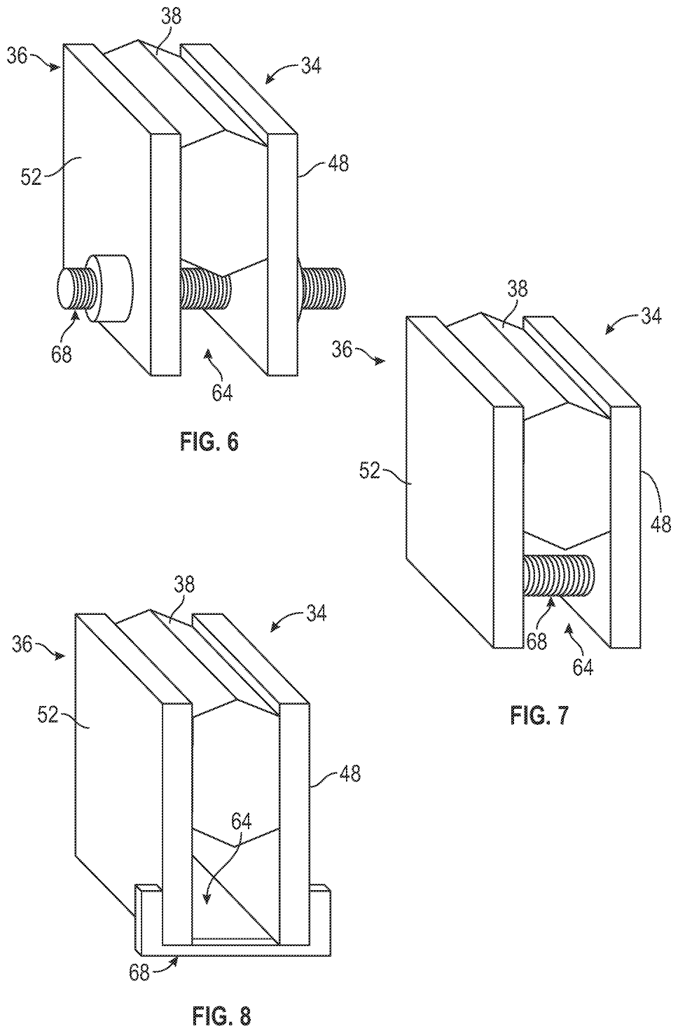

Referring to FIG. 6, the first peripheral flange 34 may be secured to the second peripheral flange 36 to increase the structural integrity of the enclosure assembly 28. In an embodiment, the vertical shield portion 48 of the first peripheral flange 34 is secured to the vertical shield portion 52 of the second peripheral flange 36 by one or more fasteners 68. At least a portion of the fastener 68 may be accommodated within the pocket 64. The fasteners 68 may include bolts (see FIG. 6), spot welds (see FIG. 7), clips (see FIG. 8), or any other suitable mechanical fastener. Multiple fasteners 68 may be provided along an outer circumference of the enclosure assembly 28 of the traction battery pack 18.

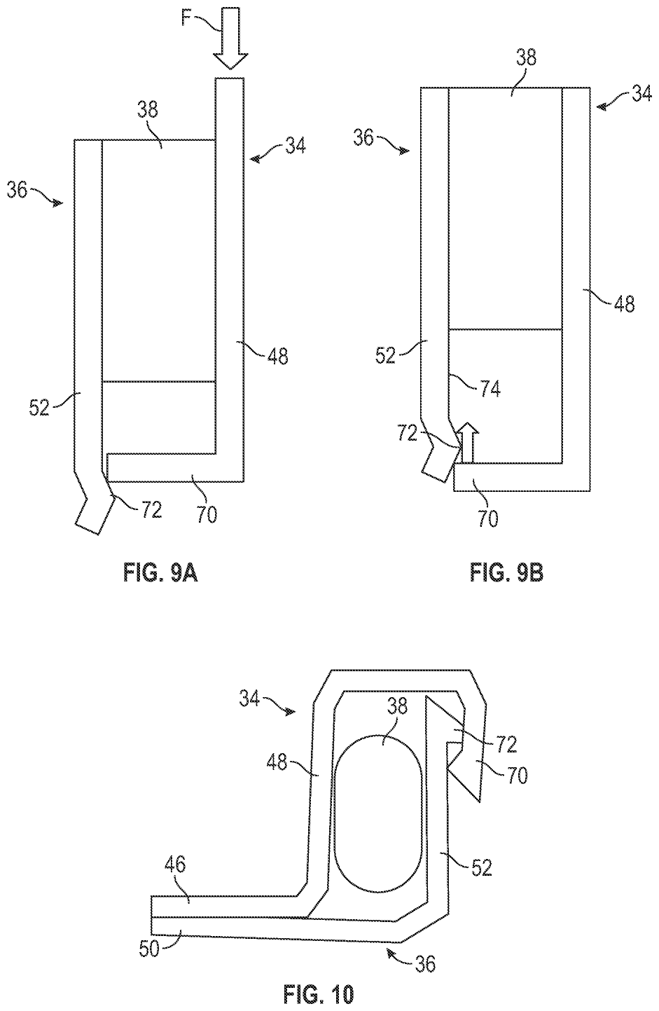

Referring to FIGS. 9A and 9B, the first peripheral flange 34 may be secured relative to the second peripheral flange 36 using a “boltless” design. For example, in this embodiment, the vertical shield portion 48 of the first peripheral flange 34 may include a hook feature 70, and the vertical shield portion 52 of the second peripheral flange 36 may include a dent feature 72. The dent feature 72 may be provided about an entire outer circumference 74 of the vertical shield portion 52 or at only select portions thereof.

As the first peripheral flange 34 is pushed toward the second peripheral flange 36 via a force F during assembly (see FIG. 9A), the hook feature 70 may pass around the dent feature 72, thereby resulting in firm engagement of the first peripheral flange 34 relative to the second peripheral flange 36 (see FIG. 9B). Once engaged relative to the dent feature 72, the hook feature 70 may be arranged to guard the gasket seal 38 from moisture, mud, debris, etc.

The above embodiments describe a downward-extending configuration in which the vertical shield portions 48, 52 extend downwardly relative to the horizontal shield portions 46, 50. However, in another embodiment shown in FIG. 10, an upward-extending configuration can also be provided in which the vertical shield portions 48, 52 extend upwardly relative to the horizontal shield portions 46, 50. The second peripheral flange 36 may thus at least partially surround, envelop, or wrap around the first peripheral flange 34 to shield the gasket seal 38. In this embodiment, the vertical shield portion 48 of the first peripheral flange 34 may include the hook feature 70 and the vertical shield portion 52 of the second peripheral flange 36 may include the dent portion 72 for firmly engaging the first peripheral flange 34 relative to the second peripheral flange 36 during assembly.

The exemplary traction battery packs of this disclosure incorporate shield features for protecting the structural integrity and reducing the maximum skin temperatures of a gasket seal. The shield features are further configured to reduce assembly complexity, reduce required packaging space, and prevent moisture from entering into the interior of the traction battery pack.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
an enclosure assembly including a first enclosure section and a second enclosure section;
a gasket seal arranged within a pocket between a first peripheral flange of the first enclosure section and a second peripheral flange of the second enclosure section; and
an air gap arranged between the first peripheral flange and the second peripheral flange at a location inboard from the gasket seal.

2. The traction battery pack as recited in claim 1, wherein the first peripheral flange at least partially envelops the second peripheral flange.

3. The traction battery pack as recited in claim 2, wherein the first peripheral flange includes a horizontal shield portion and a vertical shield portion that extends from the horizontal shield portion, and the second peripheral flange includes a horizontal shield portion and a vertical shield portion that extends from the horizontal shield portion.

4. The traction battery pack as recited in claim 3, wherein the horizontal shield portion of the first peripheral flange extends over the horizontal shield portion of the second peripheral flange.

5. The traction battery pack as recited in claim 3, wherein the gasket seal is arranged between the vertical shield portion of the first peripheral flange and the vertical shield portion of the second peripheral flange.

6. The traction battery pack as recited in claim 5, comprising a fastener that secures the vertical shield portion of the first peripheral flange to the vertical shield portion of the second peripheral flange.

7. The traction battery pack as recited in claim 6, wherein the fastener includes a bolt.

8. The traction battery pack as recited in claim 6, wherein the fastener includes a spot weld or a clip.

9. The traction battery pack as recited in claim 3, wherein the vertical shield portion of the first peripheral flange includes a hook feature that engages a dent feature of the vertical horizontal shield portion of the second peripheral flange.

10. The traction battery pack as recited in claim 3, wherein the air gap is between the horizontal shield portion of the first peripheral flange and the horizontal shield portion of the second peripheral flange.

11. The traction battery pack as recited in claim 3, wherein the horizontal shield portion of the first peripheral flange contacts the horizontal shield portion of the second peripheral flange at a flange-to-flange interface.

12. The traction battery pack as recited in claim 11, wherein a flat surface of the horizontal shield portion of the first peripheral flange contacts a curved portion of the horizontal shield portion of the second peripheral flange at the flange-to-flange interface.

13. The traction battery pack as recited in claim 11, wherein the air gap extends from the flange-to-flange interface to a leading edge of the gasket seal.

14. A traction battery pack, comprising:
an enclosure assembly including a first enclosure section and a second enclosure section that cooperate to establish an interior area;
a battery array positioned within the interior area;
a gasket seal arranged between a first peripheral flange of the first enclosure section and a second peripheral flange of the second enclosure section;
the first peripheral flange contacting the second peripheral flange at a flange-to-flange interface; and
air gap extending between the flange-to-flange interface and a leading edge of the gasket seal.

15. The traction battery pack as recited in claim 14, wherein the gasket seal is received in a pocket that is between a vertical shield portion of the first peripheral flange and a vertical shield portion of the second peripheral flange.

16. The traction battery pack as recited in claim 15, wherein the vertical shield portion of the first peripheral flange extends downwardly from a horizontal shield portion of the first peripheral flange, and the vertical shield portion of the second peripheral flange extends downwardly from a horizontal shield portion of the second peripheral flange.

17. The traction battery pack as recited in claim 16, wherein the horizontal shield portion of the first peripheral flange abuts the horizontal shield portion of the second peripheral flange to establish the flange-to-flange interface.

18. The traction battery pack as recited in claim 17, wherein a flat surface of the horizontal shield portion of the first peripheral flange contacts a curved portion of the horizontal shield portion of the second peripheral flange at the flange-to-flange interface.

19. The traction battery pack as recited in claim 15, comprising a fastener that secures the vertical shield portion of the first peripheral flange to the vertical shield portion of the second peripheral flange.

20. The traction battery pack as recited in claim 19, wherein the fastener includes a bolt, a spot weld, or a clip.
